(19) United States
(12) Patent Application Publication
(10) Pub. No.: US 2023/0373661 A1
(43) Pub. Date: Nov. 23, 2023

(54) PROPELLER GUARD, FLYING BODY, AND RESILIENT MEMBER

(71) Applicant: NIPPON TELEGRAPH AND TELEPHONE CORPORATION, Tokyo (JP)

(72) Inventors: Daisuke UCHIBORI, Tokyo (JP); Yujin HAMANO, Tokyo (JP); Kazuaki WATANABE, Tokyo (JP); Masafumi NAKAGAWA, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 18/029,079

(22) PCT Filed: Sep. 30, 2020
(86) PCT No.: PCT/JP2020/037374

§ 371 Date: Mar. 28, 2023

(51) Int. Cl. B64U 30/299

(52) U.S. Cl. CPC B64U 30/299; B64U 2101/26

(57) ABSTRACT

A propeller guard 2 includes: a propeller guard body 10 configured to surround a propeller 30 of a flight vehicle 20; and a repulsive member 40 provided to protrude on the propeller guard body 10 and including a first end and a second end to exert repulsive force outward from the propeller guard body 10, in which the first end 41 of the repulsive member is located outside an outer edge of the propeller guard body 10 as viewed from vertically above.

### TECHNICAL FIELD

The present disclosure relates to a propeller guard that protects a propeller of a flight vehicle, a flight vehicle, and a repulsive member.

### BACKGROUND ART

In recent years, a flight vehicle (for example, a drone, a multicopter, or the like) that flies by rotation of a plurality of propellers may be used for inspection of an infrastructure structure.

In Non Patent Literature 1, a method is disclosed of using a flight vehicle for inspection of pipeline facilities buried in the ground. When the flight vehicle flies in such a space surrounded by a wall surface, if the airframe collides with an object such as the wall surface, the propeller may be damaged and the airframe may crash. Thus, a propeller guard that protects the propeller may be attached to the airframe.

In Non Patent Literature 2, a propeller guard is devised for protecting a propeller when a flight vehicle collides with an object and preventing the flight vehicle from losing a flight balance and becoming uncontrollable even when the flight vehicle collides with the object.

### CITATION LIST

### Non Patent Literature

Non Patent Literature 1: Yoshihiko Yato et al., “Development of drone capable of coping with closed space such as sewer pipeline”, 29th Trenchless Technology Conference, 2.1, 2018
Non Patent Literature 2: Noriyuki Kanehira et al., “Development of a Drone Bridge Inspection System”, Kawada Technical Report, vol. 38, 2019

### SUMMARY OF INVENTION

### Technical Problem

However, when the flight vehicle moves in the vertical direction in a space surrounded by a wall surface, in the propeller guard devised in Non Patent Literature 2, there is a possibility that the guard frame comes into contact with the wall surface or the like and the flight vehicle cannot move, or the flight vehicle loses its balance and falls.

FIG. 5 is a cross-sectional view of a manhole. As illustrated in FIG. 5, in a manhole 50, when a manhole lid installed on the ground is opened and closed, a columnar or quadrangular prism structure 51 extends in the vertical direction in the ground, and a step 52 for a worker to go down to the underground or to go up to the ground is installed in the middle. The structure 51 is, for example, a reinforced concrete pipe. A manhole lid receiving frame 53 is provided near the road surface of the manhole 50.

FIG. 6 is a diagram illustrating a problem in a case where a flight vehicle with a propeller guard moves in a space surrounded by a wall surface, such as the manhole 50. As illustrated in FIG. 6, when a flight vehicle 100 to which a propeller guard is attached is caused to ascend in the structure 51, the propeller guard may be caught by the wall surface or the like of the structure 51. In this case, there is a possibility that the flight vehicle 100 rotates in an R direction with a contact point P1 between the propeller guard and the wall surface of the structure 51 as a fulcrum, and loses its flight balance and falls. Further, the flight vehicle 100 sucks air from above the propeller and discharges the air downward to float the airframe in the air. For that reason, when flight vehicle 100 rotates in the R direction (toward the wall surface of structure 51), the propeller sucks air from above thereof, whereby there is a possibility that the flight vehicle 100 stick to the wall surface of the structure 51.

An object of the present disclosure made in view of such circumstances is to provide a propeller guard, a repulsive member, and a flight vehicle capable of suppressing occurrence of rotation of the flight vehicle due to contact with an object.

### Solution to Problem

A propeller guard according to an embodiment includes: a propeller guard body configured to surround a propeller of a flight vehicle; and a repulsive member provided to protrude on the propeller guard body and including a first end and a second end to exert repulsive force outward from the propeller guard body, in which the first end of the repulsive member is located outside an outer edge of the propeller guard body as viewed from vertically above.

A flight vehicle according to an embodiment includes a repulsive member provided to protrude on the flight vehicle, to exert repulsive force outward from the flight vehicle, in which one end of the repulsive member is located outside an outer edge of the flight vehicle as viewed from vertically above.

A repulsive member according to an embodiment is for exerting repulsive force outward from a flight vehicle, the repulsive member being attached to a propeller guard body configured to surround the flight vehicle or a propeller of the flight vehicle such that one end of the repulsive member is located outside an outer edge of the flight vehicle as viewed from vertically above.

### Advantageous Effects of Invention

According to the present disclosure, it is possible to provide a propeller guard, a flight vehicle, and a repulsive member capable of suppressing occurrence of rotation of the flight vehicle due to contact with an object.

### BRIEF DESCRIPTION OF DRAWINGS

FIG. 1 is an example of a perspective view of a flight vehicle including a propeller guard according to an embodiment.

FIG. 2 is an example of a side view of the flight vehicle including the propeller guard according to the embodiment.

FIG. 3 is a diagram illustrating a state in which the flight vehicle including the propeller guard according to the embodiment comes into contact with a wall surface during movement vertically upward.

FIG. 4 is an example of a top view of a propeller guard including a plurality of repulsive members.

FIG. 5 is an example of a cross-sectional view of a manhole.

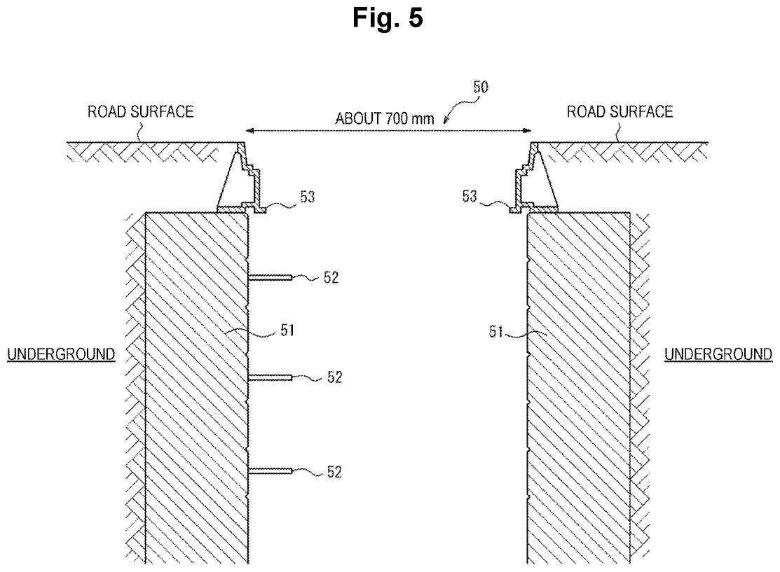

FIG. 6 is a diagram illustrating a problem of a flight vehicle with a conventional propeller guard.

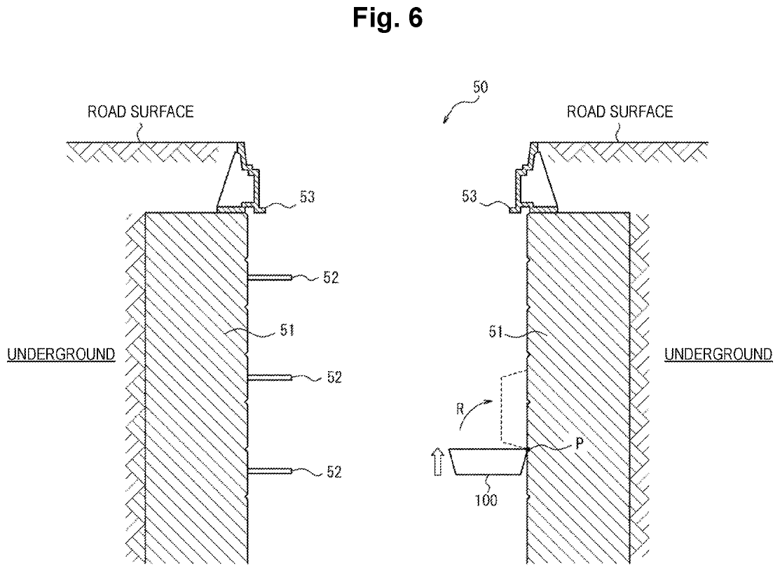

### DESCRIPTION OF EMBODIMENTS

Hereinafter, an embodiment will be described in detail with reference to the drawings. Note that the drawings are only schematically illustrated to the extent that the present invention can be sufficiently understood. Thus, the present invention is not limited only to the illustrated examples. In addition, for convenience of illustration, scales in the drawings may be different from actual scales, or may not match between the drawings.

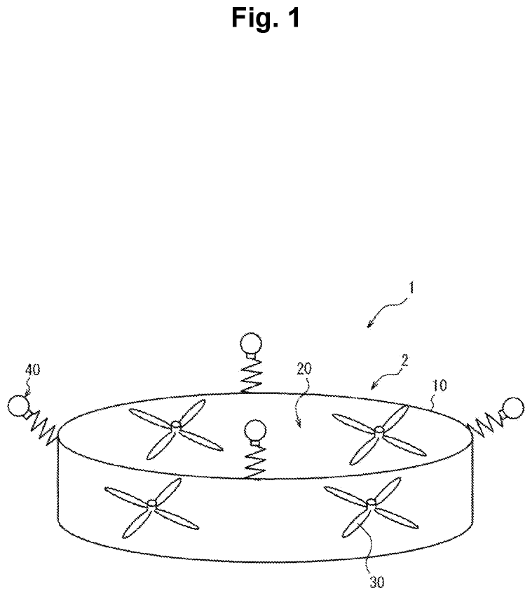

FIG. 1 is an example of a perspective view of a flight vehicle including a propeller guard according to an embodiment. A flight vehicle with a propeller guard (Hereinafter, it is simply referred to as a “flight vehicle”) 1 illustrated in FIG. 1 includes a propeller guard body 10, a flight vehicle body 20, one or more propellers 30, and a repulsive member 40. Among them, the propeller guard body 10 and the repulsive member 40 constitute a propeller guard 2. The flight vehicle 1 flies by the one or more propellers 30 each having a vertical rotation axis.

The propeller guard body 10 is configured to surround the propellers 30, and protects the propellers 30. The propeller guard body 10 may be configured to surround not only the propellers 30 but also a whole of the flight vehicle body 20, or may be configured to surround a part of the flight vehicle body 20. The following drawings illustrate the propeller guard body 10 surrounding the whole of the flight vehicle body 20.

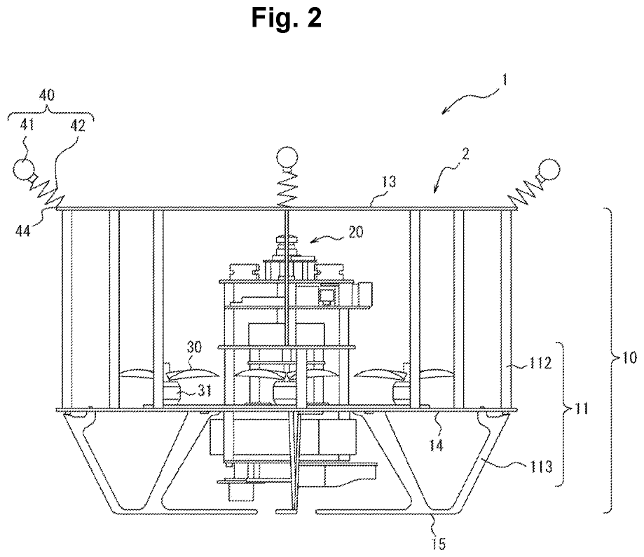

FIG. 2 is an example of a side view of the flight vehicle 1 including the propeller guard 2 according to the embodiment. The propeller guard 2 includes the propeller guard body 10 and the repulsive member 40. In the example illustrated in FIG. 2, the propeller guard body 10 includes a coupling frame 11, an upper frame 13, a lower frame 14, and a base frame 15. The number of coupling frames 11 is not limited to one, and can be arbitrarily determined. Note that an intermediate frame parallel to the upper frame 13 and the lower frame 14 may be further provided between the upper frame 13 and the lower frame 14. Whether or not to provide the intermediate frame and the number of the coupling frames 11 and the intermediate frames affect strength of the propeller guard body 10 when the flight vehicle 1 comes into contact with an object. Thus, for example, in a case where it is assumed that the flight vehicle 1 is moved at a high speed, one or a plurality of the intermediate frames may be provided and the number of the coupling frames 11 may be increased to increase the strength of the propeller guard body 10.

The upper frame 13 is a frame provided on the uppermost surface of the propeller guard body 10.

The lower frame 14 is a frame provided below the upper frame 13 and substantially parallel to the upper frame 13. A motor 31 for the propeller 30 is mounted on the lower frame 14.

The base frame 15 is installed below the lower frame 14 (at the lowermost surface of the propeller guard body 10) substantially parallel to the upper frame 13, and is a frame to be in contact with an object such as the ground at the time of landing of the flight vehicle 1. The base frame 15 provides stability at the time of landing of the flight vehicle 1 and protects the bottom of the flight vehicle 1. Center points of the upper frame 13, the lower frame 14, and the base frame 15 are desirably located on a center axis of the flight vehicle body 20 to balance the flight vehicle during flight.

The coupling frame 11 is a frame that couples the upper frame 13, the lower frame 14, and the base frame 15 together. The coupling frame 11 includes a first coupling portion 112 that couples the upper frame 13 and the lower frame 14 together, and a second coupling portion 113 that couples the lower frame 14 and the base frame 15 together. In the example of FIG. 2, the upper frame 13, the lower frame 14, the base frame 15, and the coupling frame 11 constitute the propeller guard body 10 configured to surround the propellers 30 of the flight vehicle body 20. The shape of the propeller guard body 10 illustrated in FIG. 2 is an example. In addition, for simplicity of explanation, in the following embodiment, as an example, the propeller guard body 10 has an outer edge that appears circular as viewed from vertically above. However, the propeller guard body 10 can have any shape.

The repulsive member 40 is provided to protrude on the propeller guard body 10 and acts to exert repulsive force outward from the propeller guard body 10. In the example of FIG. 2, the repulsive member 40 includes a first end 41, an elastic member 42, and a second end 44. The second end 44 of the repulsive member 40 is attached to the upper frame 13. The first end 41 as one end of the repulsive member 40 is located outside an outer edge of the propeller guard body 10 as viewed from vertically above. In the example of FIG. 2, a main body of the repulsive member 40 includes the elastic member 42 having elastic force, such as a spring.

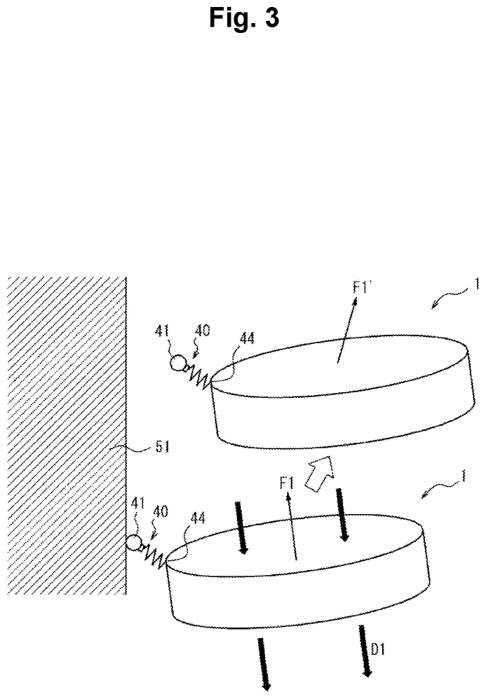

FIG. 3 illustrates a state in which the flight vehicle 1 including the propeller guard body 10 and the repulsive member 40 according to the embodiment comes into contact with a wall surface during movement vertically upward. As illustrated in FIG. 3, it is assumed that when the flight vehicle 1 to which the propeller guard 2 is attached is caused to ascend in a structure 51, the flight vehicle 1 discharges air in a D1 direction and moves in an F1 direction, and the repulsive member 40 comes into contact with the wall surface or the like of the structure 51. In this case, the repulsive member 40 exerts repulsive force outward from the propeller guard body 10 through the first end 41. For that reason, the flight vehicle 1 instantaneously moves away from the structure 51 and changes its course in an F1′ direction. Thus, it is possible to prevent the flight vehicle 1 from rotating with a contact point between the propeller guard body 10 and the wall surface of the structure 51 as a fulcrum or the flight vehicle 1 from sticking to the wall surface of the structure 51.

Note that, the second end 44 of the repulsive member 40 may be located at the outer edge of the propeller guard body 10 as viewed from vertically above. As a result, it is possible to minimize the length of the repulsive member 40.

In addition, the first end 41 of the repulsive member 40 may be located above the second end 44 of the repulsive member 40. As a result, when the flight vehicle 1 moves vertically upward, the repulsive member 40 comes into contact with the wall surface or the like of the structure 51 before the flight vehicle body 20 or the propeller guard body 10 comes into contact with the wall surface or the like of the structure 51, and repulsive force can be exerted.

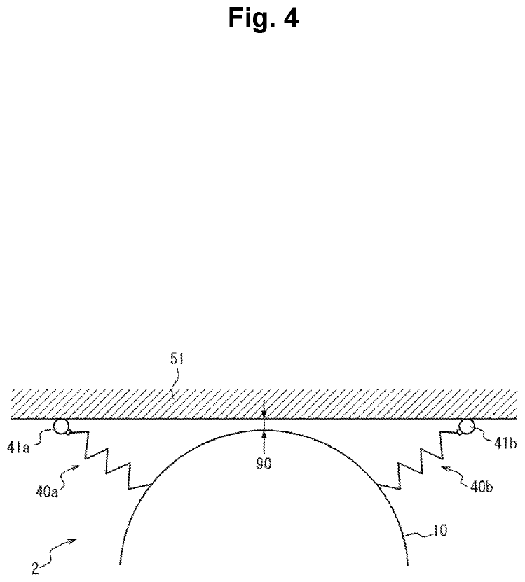

In addition, the propeller guard 2 may include a plurality of the repulsive members 40. FIG. 4 is an example of a top view of the propeller guard 2 including a plurality of repulsive members 40a and 40b. Hereinafter, an example will be described in a case where the plurality of repulsive members 40 is provided at equal intervals. In the configuration as in FIG. 4, the first repulsive member 40a and the second repulsive member 40b provided adjacent to each other may have lengths such that a vertical plane passing through a first end 41a of the first repulsive member 40a and a first end 41b of the second repulsive member 40b is located outside the outer edge of the propeller guard body 10. In FIG. 4, the first end 41a of the repulsive member 40a and the first end 41b of the repulsive member 40b provided adjacent to each other as viewed from vertically above are in contact with the structure 51. However, since a boundary of the structure 51 is outside the propeller guard body 10, there is a gap 90 between the propeller guard body 10 and the structure 51. For that reason, even in a case where the flight vehicle 1 comes into contact with the wall surface or the like of the structure 51 from any direction when moving vertically upward, the repulsive member 40 comes into contact with the wall surface or the like of the structure 51 before the propeller guard body 10 comes into contact with the wall surface or the like of the structure 51, and repulsive force can be exerted.

In addition, a part or all of the repulsive member 40 may be an elastic member. As a result, in a case where the repulsive member 40 comes into contact with the wall surface or the like of the structure 51, repulsive force can be effectively exerted.

In addition, in the above description, an example has been described in which the propeller guard body 10 includes the repulsive member 40; however, the flight vehicle 1 may include the repulsive member 40. As a result, according to a principle similar to that of the propeller guard 2 described above, the repulsive member 40 exerts repulsive force on the wall surface or the like of the structure 51, and it is possible to suppress occurrence of rotation of the flight vehicle 1 due to contact with an object. In addition, the repulsive member 40 may be provided as a component attachable to the flight vehicle body 20 or the propeller guard body 10, not in a state of being attached to the flight vehicle body 20 or the propeller guard body 10.

### REFERENCE SIGNS LIST

1 flight vehicle
2 propeller guard
10 propeller guard body
11 coupling frame
13 upper frame
14 lower frame
15 base frame
20 flight vehicle body
30 propeller
31 motor
40 repulsive member
41 first end
42 elastic member
44 second end
50 manhole
51 structure
52 step
53 manhole lid receiving frame
112 first coupling portion
113 second coupling portion

1. A propeller guard comprising:
a propeller guard body configured to surround a propeller of a flight vehicle; and
a repulsive member provided to protrude on the propeller guard body and including a first end and a second end to exert repulsive force outward from the propeller guard body,
wherein
the first end of the repulsive member is located outside an outer edge of the propeller guard body as viewed from vertically above.

2. The propeller guard according to claim 1, wherein the second end of the repulsive member is located at the outer edge of the propeller guard body as viewed from vertically above.

3. The propeller guard according to claim 1, wherein the first end of the repulsive member is located above the second end of the repulsive member.

4. The propeller guard according to claim 1, comprising a plurality of repulsive members.

5. The propeller guard according to claim 4, wherein a first one of the plurality of repulsive members and a second one of the plurality of repulsive members provided adjacent to each other have lengths such that a vertical plane passing through an end of the first one of the plurality of repulsive members and an end of the second one of the plurality of repulsive members is located outside the outer edge of the propeller guard body.

6. The propeller guard according to claim 1, wherein a part or all of the repulsive member is an elastic member.

7. A flight vehicle comprising
a repulsive member provided to protrude on the flight vehicle, to exert repulsive force outward from the flight vehicle,
wherein
one end of the repulsive member is located outside an outer edge of the flight vehicle as viewed from vertically above.

8. A repulsive member to exert repulsive force outward from a flight vehicle, the repulsive member being attached to a propeller guard body configured to surround the flight vehicle or a propeller of the flight vehicle such that one end of the repulsive member is located outside an outer edge of the flight vehicle as viewed from vertically above.

9. The propeller guard according to claim 2, wherein the first end of the repulsive member is located above the second end of the repulsive member.

10. The propeller guard according to claim 2, comprising a plurality of repulsive members.

11. The propeller guard according to claim 3, comprising a plurality of repulsive members.

12. The flight vehicle according to claim 7, further comprising:
a propeller guard body configured to surround a propeller of the flight vehicle.

13. The flight vehicle according to claim 12, wherein another end of the repulsive member is located at the outer edge of the propeller guard body as viewed from vertically above.

14. The flight vehicle according to claim 12, wherein the one end of the repulsive member is located above another end of the repulsive member.

15. The flight vehicle according to claim 12, comprising a plurality of repulsive members.

16. The flight vehicle according to claim 15, wherein a first one of the plurality of repulsive members and a second one of the plurality of repulsive members provided adjacent to each other have lengths such that a vertical plane passing through an end of the first one of the plurality of repulsive members and an end of the second one of the plurality of repulsive members is located outside the outer edge of the propeller guard body.

17. The flight vehicle according to claim 12, wherein a part or all of the repulsive member is an elastic member.

18. The flight vehicle according to claim 13, wherein the one end of the repulsive member is located above the other end of the repulsive member.

19. The flight vehicle according to claim 13, comprising a plurality of repulsive members.

20. The flight vehicle according to claim 19, wherein a first one of the plurality of repulsive members and a second one of the plurality of repulsive members provided adjacent to each other have lengths such that a vertical plane passing through an end of the first one of the plurality of repulsive members and an end of the second one of the plurality of repulsive members is located outside the outer edge of the propeller guard body.
